(19) United States
(12) Patent Application Publication
(10) Pub. No.: US 2018/0165136 A1
(43) Pub. Date: Jun. 14, 2018

(54) A SYSTEM, METHOD, COMPUTER PROGRAM AND DATA SIGNAL FOR HOSTING AND EXECUTING A PROGRAM ON A MAINFRAME

(71) Applicant: MAINFRAME CLOUD PTY LTD, Lane Cove, New South Wales (AU)

(72) Inventor: Frank Fera, Lane Cove (AU)

(21) Appl. No.: 15/739,490

(22) PCT Filed: May 23, 2016
(86) PCT No.: PCT/AU2016/050394

§ 371 Date: Dec. 22, 2017

Related U.S. Application Data
(60) Provisional application No. 62/167,353, filed on May 28, 2015.

(30) Foreign Application Priority Data
May 21, 2015 (AU) 2015901864

(51) Int. Cl. G06F 9/54; G06F 9/455; H04L 29/08

(52) U.S. Cl. CPC G06F 9/541; G06F 9/547; H04L 67/025; H04L 67/06; G06F 9/45529

(57) ABSTRACT

The present invention provides, in one embodiment, method of hosting at least one program on a mainframe system, The method comprises the steps of providing to the mainframe system an agent application arranged to interface with at least one of the operating system and the hardware of the mainframe, the agent including an Application Program Interface arranged to receive at least one instruction from a remote source. Upon the instruction being received, the agent application executing the instruction on the mainframe.

### FIELD OF THE INVENTION

The present invention relates to a system, method, computer program and data signal hosting and executing a program on a mainframe. Embodiments of the invention find particular, but not exclusive, use in the provision of an executable program which executes within a virtual server on the mainframe. In one specific embodiment, the invention relates to the provision of a virtual server within a mainframe computing system, to allow one or more programs to be executed by the mainframe within the virtual server.

### BACKGROUND OF THE INVENTION

Mainframe computers, despite assertions to the contrary, are enjoying a renaissance. The term ‘mainframe’ originally referred to the large cabinets that held the components of first generation computing systems. As computers became smaller and began to penetrate many market sectors and organisations, the term ‘mainframe’ came to refer to high-end, commercial computers used by large corporate and government organisations to process very large numbers of computing tasks (‘transactions’).

Mainframe computers are distinguished from other computing systems by engineering that results in very high reliability (e.g. through the use of redundant systems and high quality components), extensive input-output facilities to process a very high volume of transactions, high hardware utilisation rates through software (and hardware) processes that allow for virtualisation of hardware, and strong backward compatibility between successive generations of mainframe hardware and software. In other words, mainframe computers are built for reliability and dependability in critical applications where failure (either in hardware or software) could have serious financial or real world consequences.

As such, mainframe computers are the computers used by large corporate and governmental organisations to process very large volumes of data in critical applications (such as financial transactions, military exercises, etc).

Over time, with the development of personal computers, widely distributed computing networks (such as the Internet), newer and cheaper ways of achieving redundancy (e.g. via a network of low-cost computers), more sophisticated manufacturing techniques which resulted in more reliable hardware across all sectors of the computer market, and the exponential growth in computing power coupled with the simultaneous miniaturisation of electronic circuitry, resulted in smaller computers that were reliable enough to be used for many tasks traditionally reserved for mainframe computers. In turn, mainframe computers remained very specialist and niche computers, used by only a handful of institutions for very specific applications.

Many commentators were of the opinion that mainframe computers would slowly die out, as the traditional user base of mainframe computers, such as banks, insurance companies, government departments, etc., moved to different types of computing systems for many of their ancillary (and core) computing needs.

However, with the explosion of Internet commerce and the revived need for ultra-secure and ultra-reliable computers that are optimised for transaction processing, there has been a renewed interest and uptake in mainframe computing.

It is against this background that embodiments of the invention have been developed.

### SUMMARY OF THE INVENTION

In a first aspect of the invention, there is provided a method of hosting at least one program on a mainframe system, comprising the steps of providing to the mainframe system an agent application arranged to interface with at least one of the operating system and the hardware of the mainframe, the agent including an Application Program Interface arranged to receive at least one instruction from a remote source, wherein, upon the instruction being received, the agent application executing the instruction on the mainframe.

In one embodiment, the method includes the further step of starting a virtual server on the mainframe computing system, wherein the at least one instruction is executed within the virtual server.

In one embodiment, the at least one instruction is an application received by the agent application.

In one embodiment, the at least one instruction is in the form of a processable job.

In one embodiment, the processable job is a Job Control Language (JCL) job.

In one embodiment, the processable job is a Java Application.

In one embodiment, the mainframe receives the processable job file using the File Transfer Protocol (FTP).

In one embodiment, the agent application includes a virtual processor and a communications layer.

In one embodiment, the agent application is capable of interfacing with at least one of a System Display and Search Facility (SDSF), a SYSLOG Interface, a Time Sharing Option (TSO) interface, a DATASET Interface, a USER Commands Interface and a MVS System Commands Interface.

In a second aspect of the invention, there is provided a system for hosting at least one program on a mainframe system, comprising an agent application arranged to interface with at least one of the operating system and the hardware of the mainframe, the agent including an Application Program Interface arranged to receive at least one instruction from a remote source, wherein, upon the instruction being received, the agent application executing the instruction on the mainframe.

In one embodiment, the system includes a virtual server, wherein the at least one instruction is executed within the virtual server.

In one embodiment, the at least one instruction is an application received by the agent application.

In one embodiment, the at least one instruction is in the form of a processable job.

In one embodiment, the processable job is a Job Control Language (JCL) job.

In one embodiment, the processable job is a Java Application.

In one embodiment, the mainframe receives the processable job file using the File Transfer Protocol (FTP).

In a third aspect of the invention, there is provided a software application which includes at least one instruction, which, when executed by a computing system, carries out the method steps in accordance with the second embodiment of the invention.

In a fourth aspect of the invention, there is provided a data signal including at least one encoded instruction which, when executed by a computing system, carries out the method steps in accordance with the second embodiment of the invention.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 illustrates an example system usable to operate an embodiment of the present invention.

FIG. 2 illustrates an example embodiment of a system in accordance with the present invention.

FIGS. 3 and 4A are flowcharts illustrating the steps of methods in accordance with an embodiment of the invention.

FIG. 4B is a schematic diagram illustrating an example embodiment of a system in accordance with the present invention.

### DETAILED DESCRIPTION OF EMBODIMENTS OF THE INVENTION

### Overview

A description of example embodiments of the invention follows. Like terms are used to denote functionally similar integers and features in the Figures.

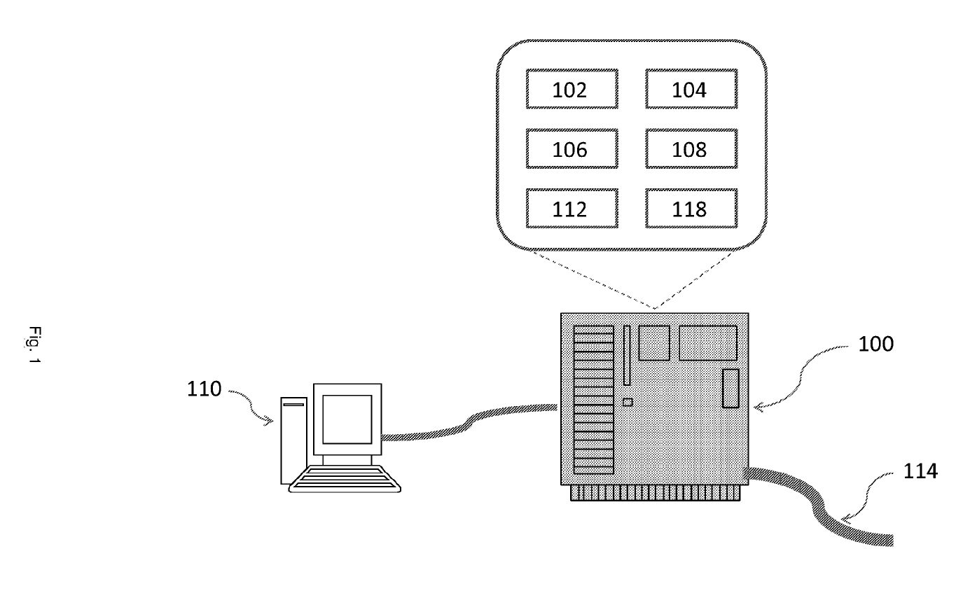

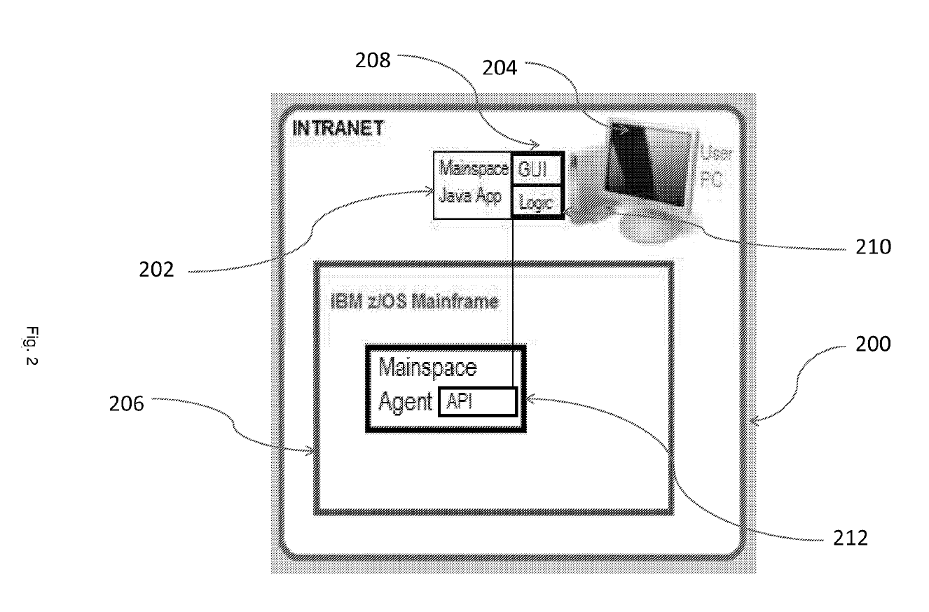

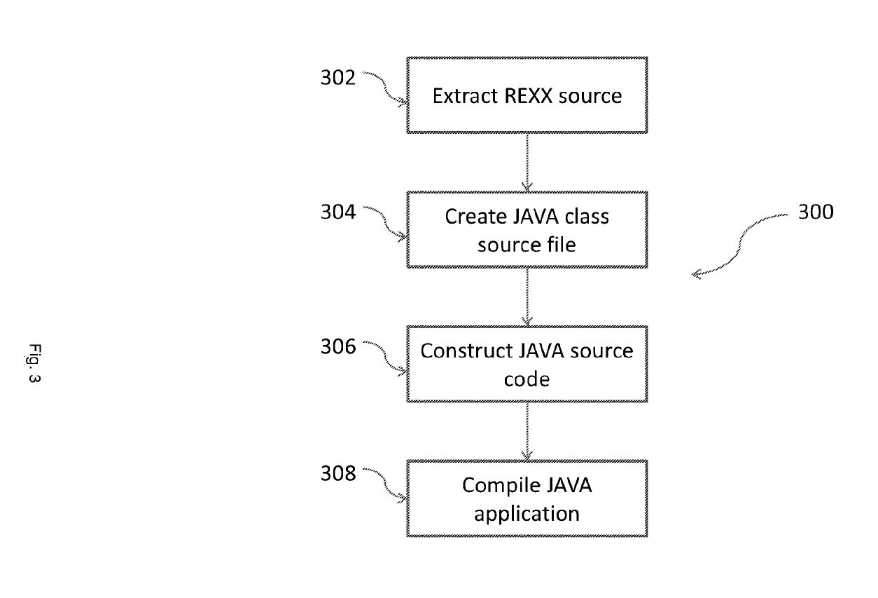

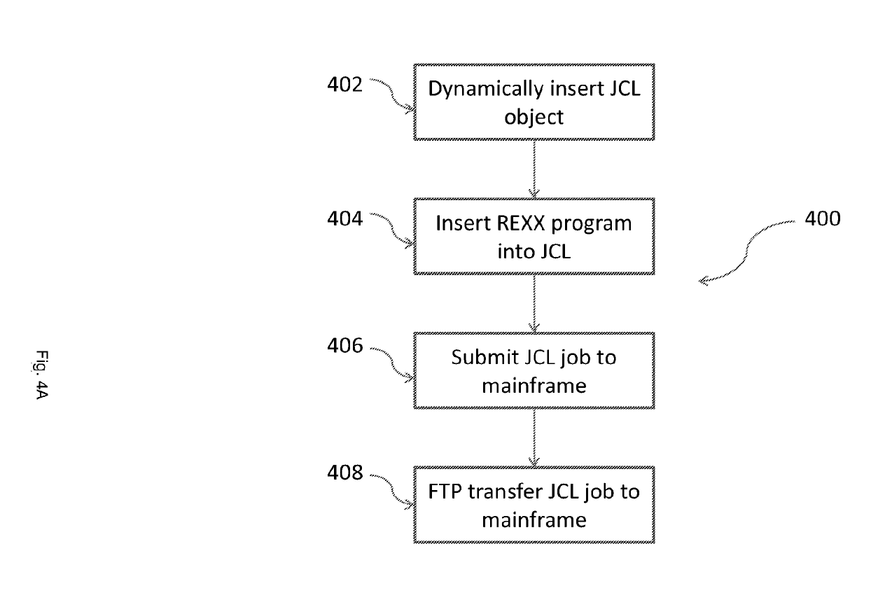

Referring to FIG. 1, there is shown an example mainframe computing system which is capable of remotely operating and executing an application in accordance with an embodiment of the present invention.

In FIG. 1 there is shown a schematic diagram of a computing system, which in this embodiment is a mainframe computer 100 suitable for use with an embodiment of the present invention. The mainframe computer 100 may be used to execute applications and/or system services such as a system and method for remotely operating and executing an application in accordance with an embodiment of the present invention.

With reference to FIG. 1, the mainframe computer 100 may comprise suitable components necessary to receive, store and execute appropriate computer instructions. The components may include one or more processors 102, read only memory (ROM) 104, random access memory (RAM) 106, input/output devices such as disc drives 108, direct input devices 110 (such as a ‘dumb terminal’) and one or more communications link(s) 114.

The mainframe computer 100 includes instructions that may be installed in ROM 104, RAM 106 or disc drives 112 and may be executed by the processor 102. There may be provided a plurality of communication links 114 which may variously connect to one or more computing devices 110 such as web servers, personal computers, laptops, wireless or handheld computing devices, or mobile communication devices such as a mobile (cell) telephone. At least one of a plurality of communications link 114 may be connected to an external computing network through a telecommunications network.

The mainframe computer 100 includes a suitable operating system 118 which may also reside on a storage device or in the ROM of the server 100. The operating system is arranged to interact one or more computer programs to cause the mainframe computer to carry out the steps, functions and/or procedures in accordance with the embodiments of the invention described herein.

Broadly, the invention relates to a method of delivering at least one program instruction to a mainframe system. The method comprises the steps of providing to the mainframe system a program embedded in at least one command as a processable job, the program including a server module arranged to operate as a virtual server. Upon the processable job being executed on the mainframe, the virtual server is started and is capable of receiving further instructions to operate the mainframe computing system.

Other aspects of the broad inventive concept relate to a corresponding method and data signal.

### No-Install Technology—Packaging and Deploying Applications to a Mainframe

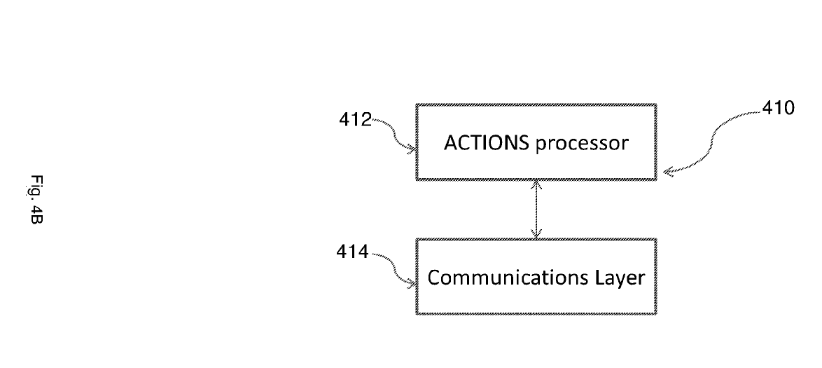

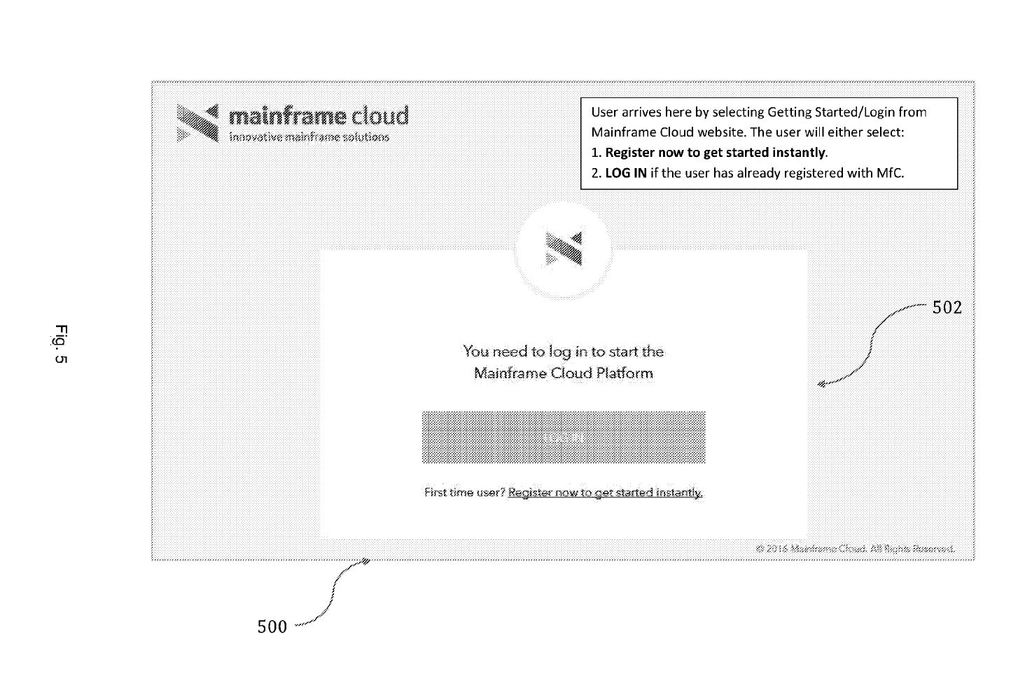

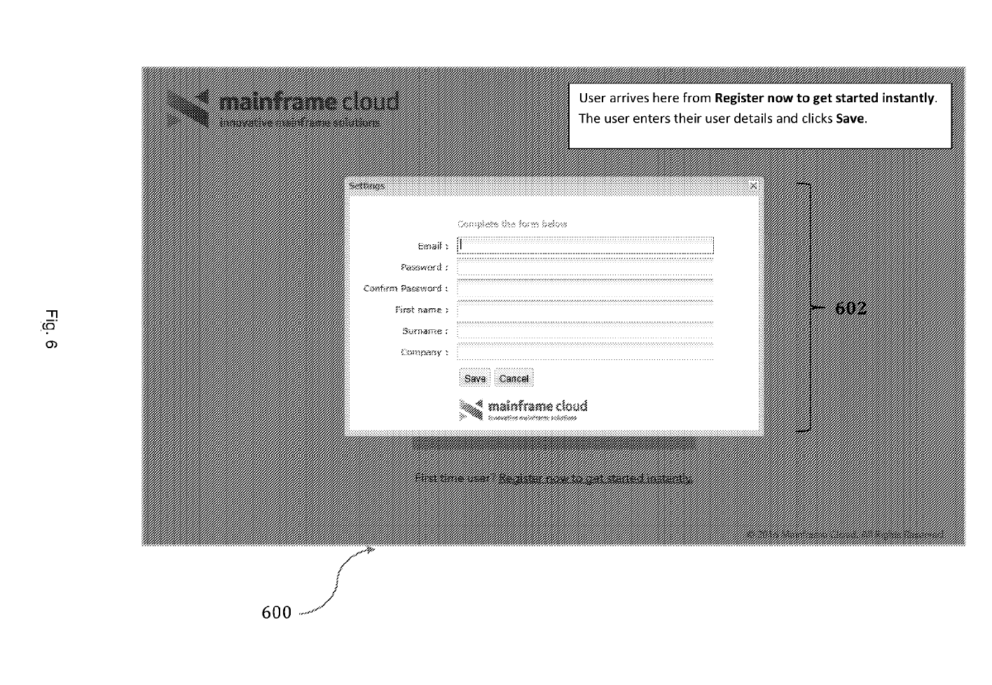

Referring now to FIG. 2, there is shown a schematic diagram of a system 200 which includes a Mainspace™ Java Application 202 (i.e. app software application) which operates on a personal computer 204. The personal computer 204 is in communication (e.g. via a network or via a direct cable connection, not shown) to a mainframe computing system 206, the system 200 being a system in accordance with an embodiment of the present invention.

In the ensuing description, reference may be made to the ‘Mainspace’ trade mark, a trade mark of Mainframe Cloud Pty Ltd, an Australian limited company. The ‘Mainspace’ trade mark is used in the ensuing description to refer to one specific commercial embodiment of the invention and no ‘gloss’ should be taken from the use of the trade mark or the specific reference to features of the commercial embodiment to limit the broader invention defined and described herein. The commercial embodiment is described solely to assist the reader in better understanding one embodiment of the invention, and the description of the commercial embodiment should be taken at all times as being illustrative rather than restrictive.

Returning to FIG. 2, the Mainspace Java App 202 includes appropriate code to operate a Graphical User Interface (GUI) 208, and certain aspects of the mainframe program logic 210. The Mainspace Java App 202, once deployed, interfaces with the mainframe computing system 206 to launch and operate a Mainspace Agent program 212, as shown in FIG. 2. The process by which the Mainspace Java App and Mainspace Agent operate are described in more detail below.

It will be understood that the Mainspace Java App is the subject of the present application, and the Mainspace Agent is the subject of a co-pending application.

In the context of the embodiment described herein, the Mainspace Agent is the vehicle by which the mainframe program is deployed on the mainframe (i.e. the program the user wishes to deploy and execute on the mainframe computing system).

In the embodiment described, the mainframe program is written in the REstructured eXtended eXecutor (REXX) language, which is an interpreted programming language written developed by IBM, a US corporation (see http://www.ibm.com/rexx/). The program is stored in a conventional personal computer file file in the REXX format. For the purpose of the ensuing description, reference will be made to a single Mainspace agent (i.e. the mainframe program). However, it will be understood that the user may have multiple mainframe programs.

The Mainspace Agent is run on the mainframe via a Job Control language (JCL) job, which is a scripting language used on IBM mainframes (see, for example, http://www.sedbooks.ibm.com/redbooks/pdfs/sg247436.pdf for an introduction to JCL).

That is, the Mainspace Agent, which is programmed in REXX, is ‘packaged’ into a JCL job. The JCL job is then submitted to the mainframe over the network (usually by using the File Transfer Protocol (FTP) and once submitted, the JCL job runs the Mainspace Agent REXX program on the mainframe within a virtual server which is opened up by the Mainspace agent program within the mainframe computer.

The JCL source used to carry out this process is also coded and stored in a conventional personal computer file in a conventional JCL format.

### Packaging

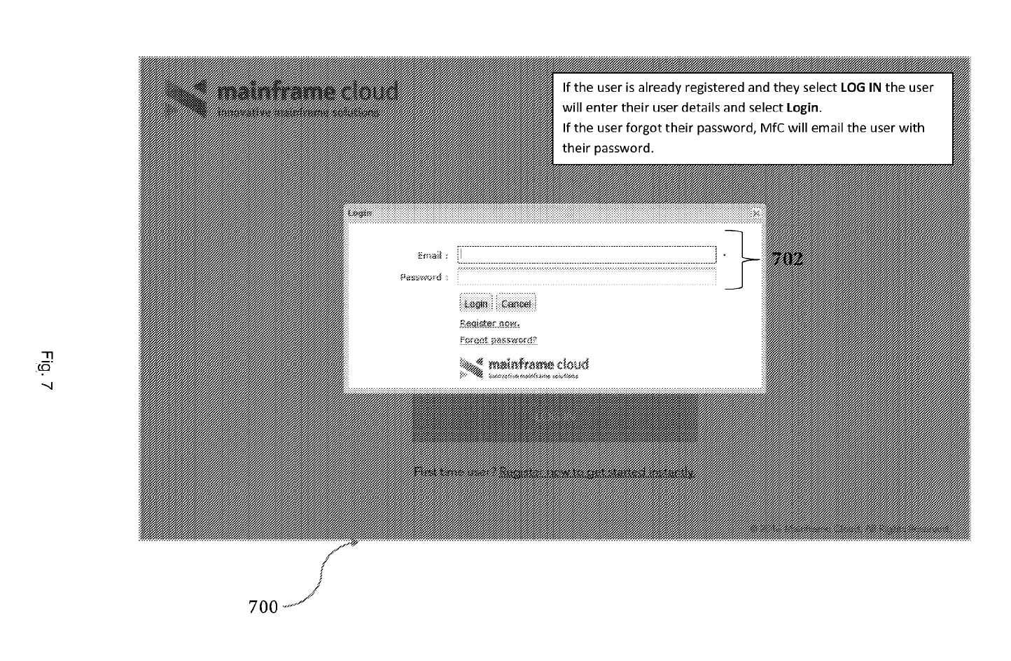

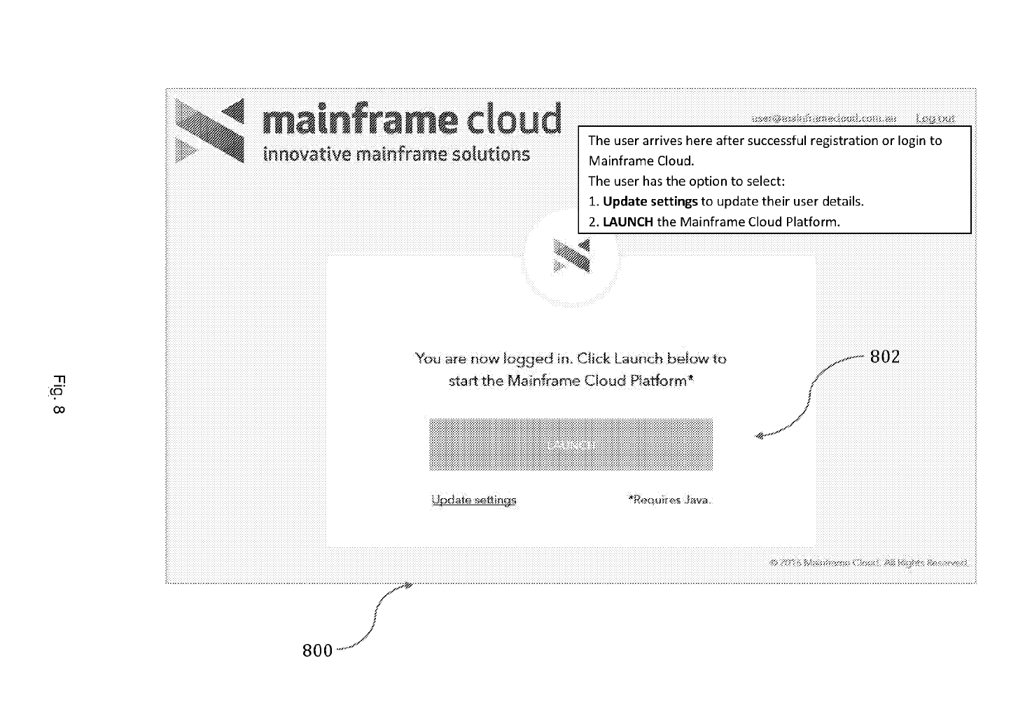

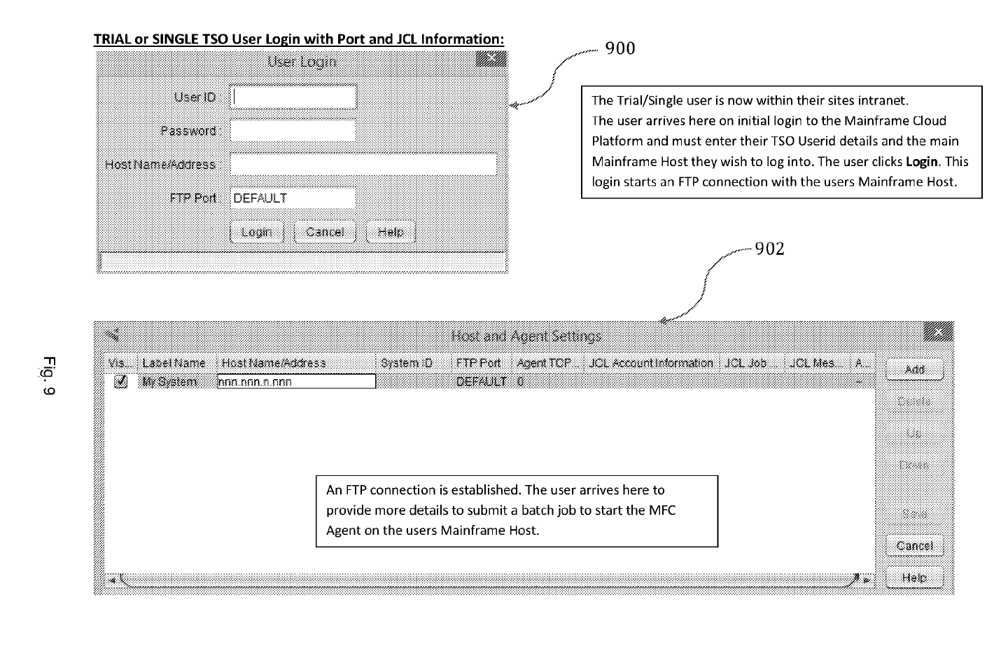

Referring to FIG. 3, the process of packaging will now be described in more detail with reference to flow chart 300. When packaging the Mainspace Java application a custom built batch process is utilised.

The batch process comprises the following steps. Firstly, at step 302 the REXX source is extracted. Secondly, at step 304 a Java class source file (“ZZAGENTREXX.java” Java program) is created within the Mainspace Java application project (to replace the existing file of the same name).

Thirdly, at step 306, Java source code is constructed (i.e. the code is generated automatically by the batch process) to assign the content of the REXX source to a Java object variable. Fourthly, at step 308, the Mainspace Java application is compiled, resulting in the Mainspace mainframe code residing within the Mainspace Java application as a Java object.

The same steps are taken for the JCL source (creates Java source file ZZAGENTJCL.java). The “mainframe entity java objects” generated in this way are then ready to be used to launch the application on the mainframe, as described below.

### Launch Time

To launch a program on the mainframe, a user executes the Mainspace PC Java application, to have access to one or more Mainspace Agents.

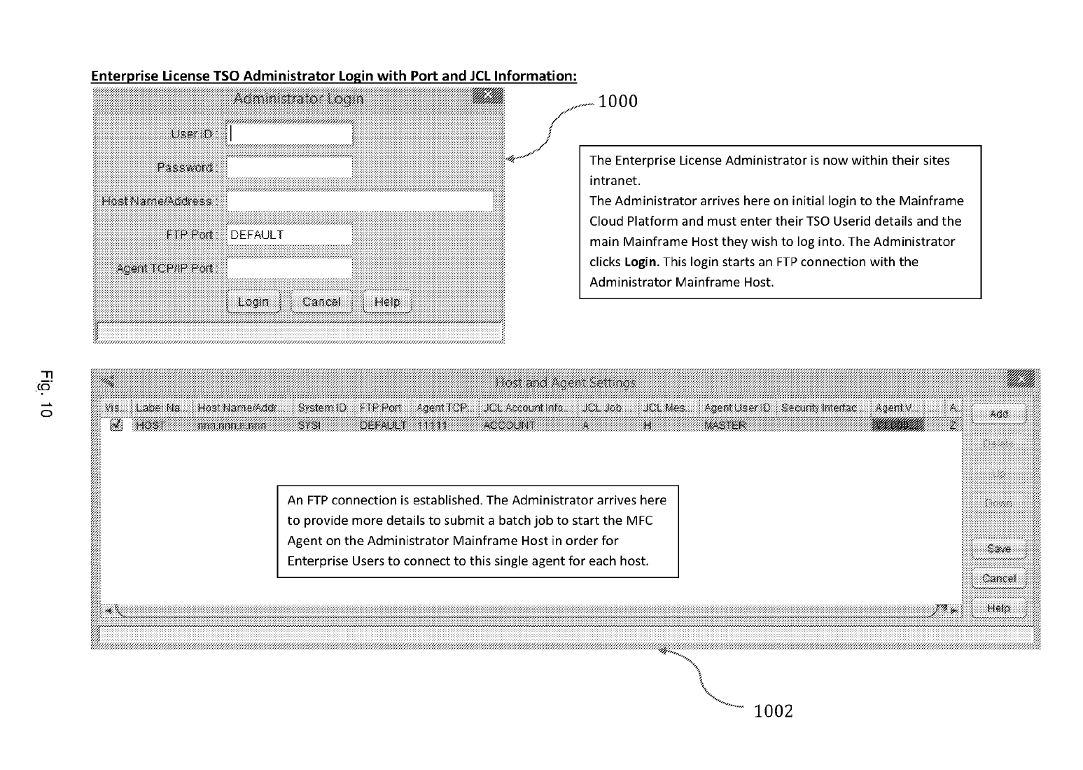

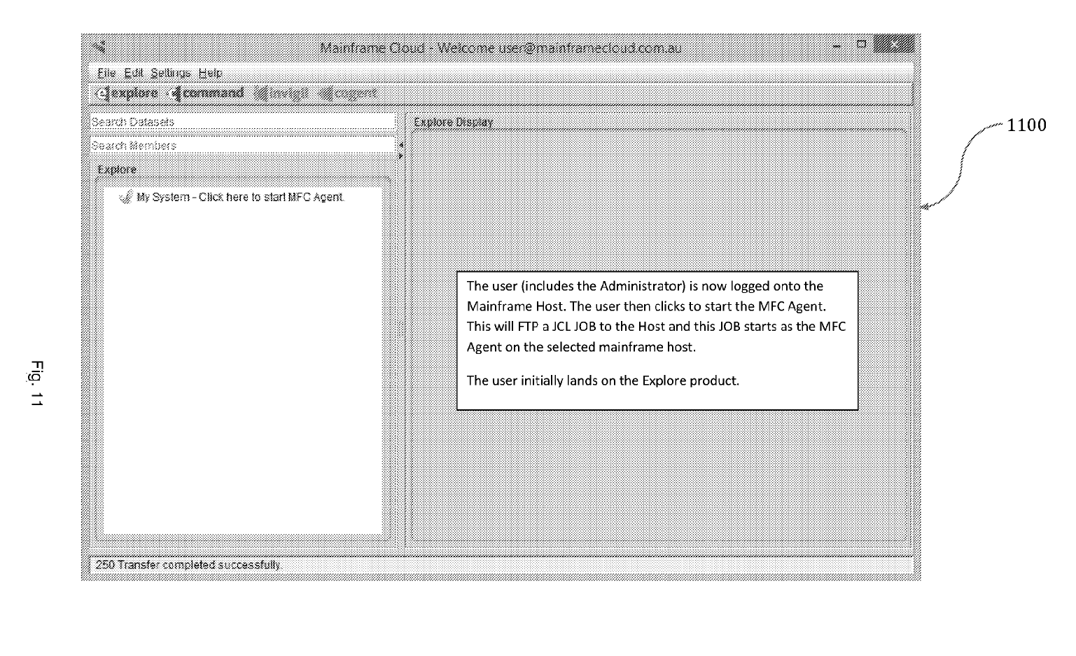

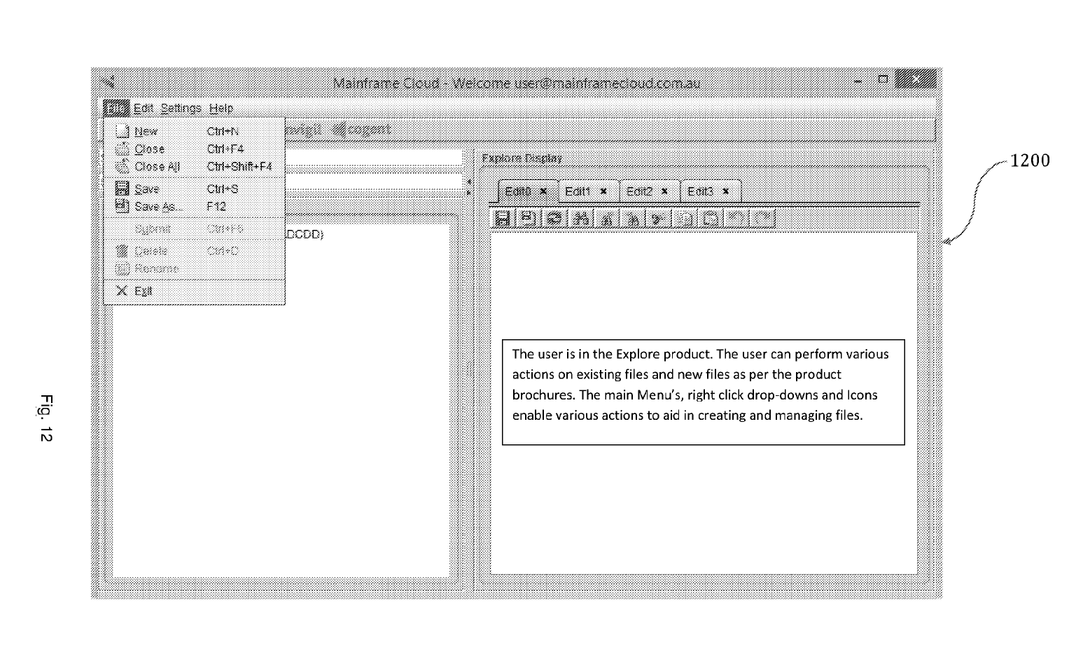

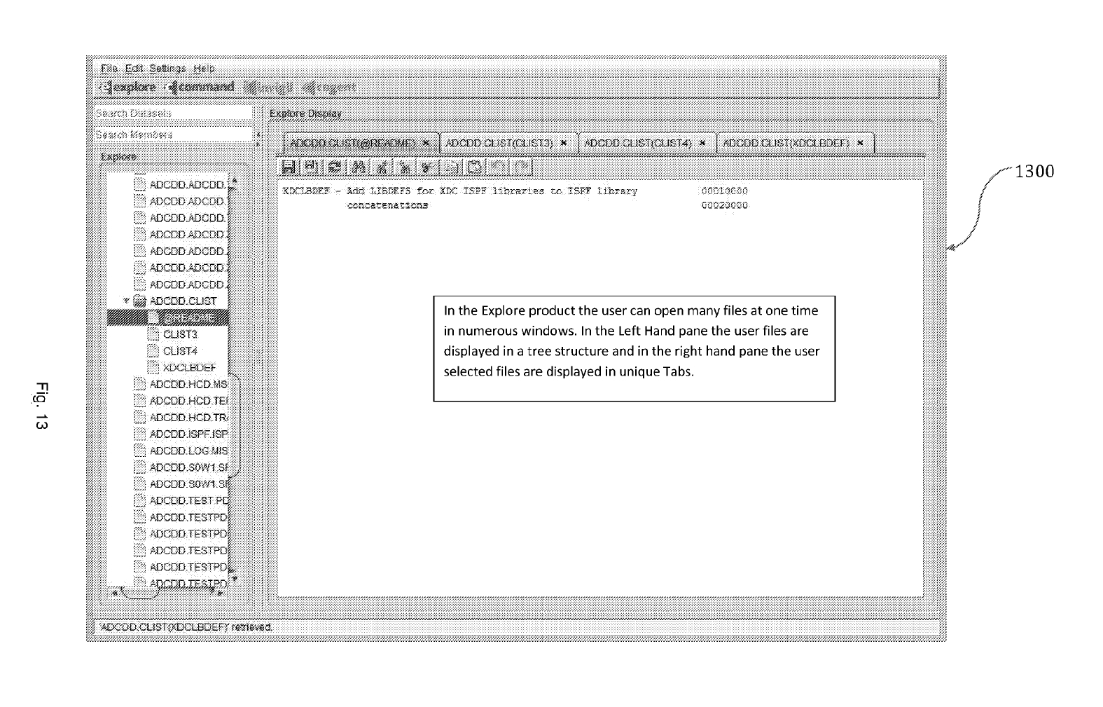

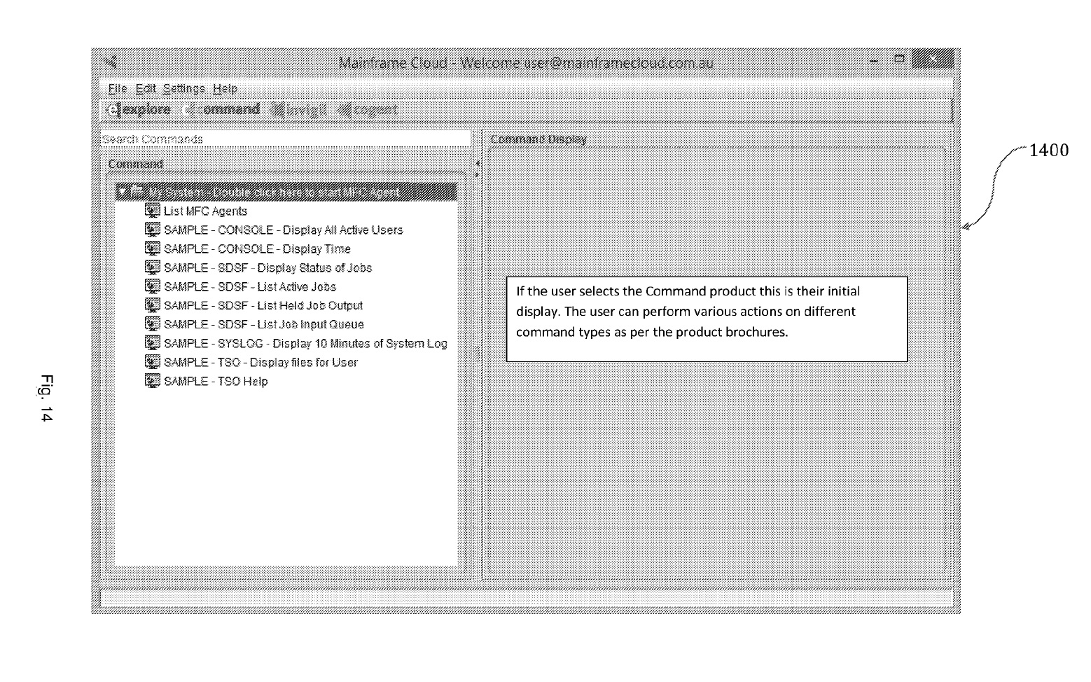

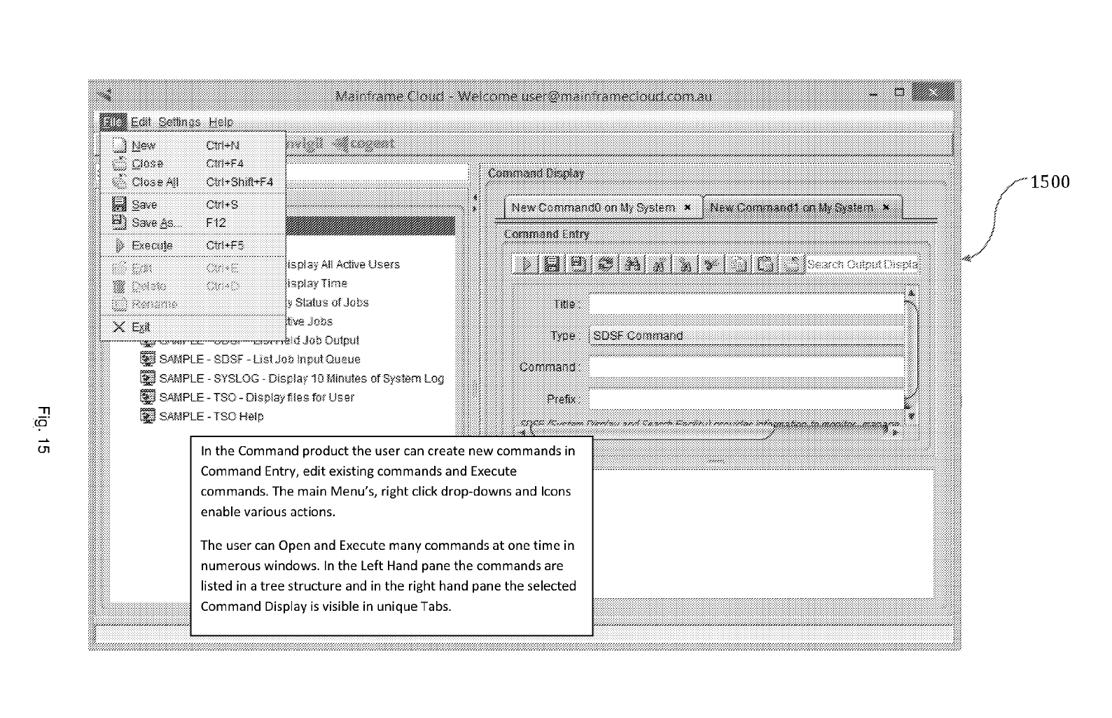

The user may then, at their discretion, execute a “Start Mainspace Agent” action, which results in the process described generally at FIG. 4A with reference to flow chart 400.

Firstly, at step 402, the JCL object described above is dynamically inserted with required user profile data (setup information preferences previously defined by the user via a setup dialog), programmatic information required to allow multiple Mainspace Agent submissions on the same mainframe and network information to allow the Mainspace Agent to communicate with the Mainspace Java application that submitted it.

Secondly, at step 404, the JCL object is inserted with the Mainspace Agent REXX program.

Thirdly, at step 406, the JCL is submitted to run on the mainframe from the Mainspace Java PC application using the technique described below.

### Execution of Application

Firstly, at step 408, the JCL job is transferred to the mainframe. When transferring a file to the mainframe using FTP, the FTP SITE COMMAND “FILETYPE=JES” can be used to flag with the mainframe that the uploaded file is to be executed as a JCL job. In this way the user submits a JCL job to run on the mainframe, remotely from their PC, without saving any files on the mainframe.

In the embodiment described herein, the Mainspace PC Java application includes an FTP Client program, which is used to seamlessly FTP transfer the Mainspace Agent JCL to the mainframe to start the Mainspace Agent. In other words, the user is not explicitly aware that FTP is used to transfer the file. Rather, the process occurs in the background without the user's explicit knowledge.

The standard practice for running programs from a JCL job is to code the JCL to point to an external file which contains the program to run.

It is also possible to run a program from JCL by embedding the whole program physically inside the JCL file (instream to JCL), instead of pointing to an external file. With the “mainframe entity java objects” design (building the JCL and embedded REXX dynamically within our Java application before launching to mainframe), and the FTP/JCL feature, this instream approach provides the ability to run a mainframe software solution on the mainframe without installing any software on the mainframe.

### Mainframe Interface “Proxy”

The interface proxy (referred to in FIG. 2 as the “Mainspace Agent Program 212”) is an interface designed to host programs received from the Mainspace Java App 202. Referring to FIG. 4B, the Agent program 410 (which is equivalent to 212 in FIG. 2) includes an ACTIONS processor (the API) 412 and a communications layer 414.

The communication layer is a Socket Server routine which is used to communicate with the Mainspace PC Java application that contains the software application logic and GUI code as described with reference to the no-install technology.

The ACTIONS processor interfaces with various parts of the mainframe, which are all the functional components that a mainframe user would ever need to access, in order to work on or manage the mainframe.

In the embodiment described herein, the functional components include:

### 1. SDSF Interface

The System Display and Search Facility (SDSF), a feature of IBM mainframes running z/OS, enables users and administrators to view and control various aspects of mainframes' operation. These include:
Jobs and output;
Devices, such as printers, readers, lines, and spool offloaders;
Checks from IBM Health Checker for z/OS;
System resources, such as WLM scheduling environments, the members of your MAS, and JES job classes;
Status of Unix System Services processes;
System information; and
System log and action messages.

### 2. SYSLOG Interface

The System log, a part of SDSF, is a widely used utility by mainframe professionals to diagnose mainframe system activity. Its current green screen character based MS-DOS like display is an extremely cumbersome utility to work with, especially when several iterations of searching is usually required for any given task. The Mainspace system log interface implements a useful windows like graphical user interface with scrolling and advanced filtering which is a powerful tool for daily use and also an important part of Mainspace applications requiring programmatic log analysis.

### 3. TSO Commands Interface

Time Sharing Option (TSO) is an interactive time-sharing environment for IBM mainframe operating systems. Allows users to create an interactive session with the z/OS system, and commands interface to z/OS. TSO Commands control access to the system, determines terminal characteristics, allows communication between TSO users, executes programs and manages data sets.

### 4. DATASET Interface

A PDS dataset, SEQ dataset and members are the PC equivalent of folders and files on the mainframe. The DATASET interface is a powerful tool for performing all dataset actions on the mainframe, including read, write, delete, rename, copy, create, and all other administrative file related tasks.

### 5. USER Commands Interface

Much like TSO commands, the user command interface allows the execution of user written procedures (REXX programs, or CLIST programs). Where a specific function is not supported, the ability to allow users to create their own functions, allows the possibility to perform custom solutions on the mainframe.

### 6. MVS System Commands Interface

MVS (Multiple Virtual Storage) is an operating system from IBM that continues to run on many of IBM's mainframe and large server computers. The tasks of starting, running, and stopping the MVS operating system involve controlling the MVS system software and most of the installation's hardware, including processors, channel paths, and I/O devices. MVS system commands control the z/OS operating system. MVS system commands can be used to display device status and channel paths, and display or change the SMS configuration.

Combined, the functional components provide the functionality required to monitor and control various aspects of mainframes' operation, including but not limited to mainframe applications, system information, resources, network, log files and mainframe files.

Referring now generally to FIGS. 5 to 13, there are shown various screenshots of an embodiment of the invention. The screenshots shown generally at FIGS. 5 to 13 are to an web-based “application” arranged to operate on a personal computer, but it will be understood that the broader inventive concept contemplates any type of application, such as a an applet, an app operating on a portable tablet or mobile (cell) telephone device, or any other type of computing system that may potentially interface with a mainframe computing system.

Referring to FIG. 5, there is shown a login screen 500 presented to a user including a login button 502. Once the user clicks the login button, the user is taken to the screen shown in either FIG. 6 or FIG. 7.

If the user has not yet registered an account with the provider of the embodiment of the invention, they are taken to a “register” screen at FIG. 6 and are required to enter identifying information at text boxes 602. Alternatively, if the user has registered an account, they are taken to a login page at FIG. 7 and can login using their email and password at text boxes 702.

Once the user is logged in, the user is taken to screen 800 at FIG. 8 and can click the “launch” button 802 to launch the application.

The user may then log into the mainframe by using the logins shown at either FIG. 9 or 10 (input boxes 900 and 1000 respectively). This takes the user to an FTP box which allows the user to then submit a batch job (input boxes 902 and 1002 respectively).

The user is now logged in and can utilise the screens generally shown at FIGS. 11 to 15. At FIG. 11, the user utilises screen 1100 to navigate the explore product, where the user can start the agent (as described earlier in the specification).

At FIG. 12, at screen 1200, the user can perform various actions on existing files and new files, including editing, importing, saving, deleting and renaming files.

At FIG. 13, at screen 1300, the user can open numerous files in multiple windows, to allow the user to operate across multiple files simultaneously.

At FIG. 14, at screen 1400, the user can switch to the command mode, which allows the user to review certain aspects of the mainframe, such as active users, status of jobs, input queue, and various other statistical and informational parameters.

At FIG. 15, at screen 1500, the user can create new complex, multi-step commands for the mainframe to execute and can do so using a series of predetermined simple commands.

### Advantages

In order to better understand the advantages that arise from embodiments of the invention, it is instructive to briefly describe prior art mainframe systems and the market forces that control software and hardware development in the mainframe computing system market. It will be understood that any reference to a prior art system is provided herein solely for the purpose of better contextualising embodiments of the present invention, and no ‘gloss’ should be taken from the description of a prior art system to limit the scope or nature of any feature of the embodiments, the embodiments as a whole, or the broader inventive concept described herein.

Mainframe computers, due to their high security, high reliability and ability to run critical applications in a dependable manner, are generally very constrained in the software applications that are installed and run, and moreover, any addition of software applications and/or upgrades to software applications are generally preceded by a long period of testing, before an application is installed on a ‘live’ mainframe. The rigorous testing and long installation process associated with mainframe software applications results in high costs and long lead times to deploy new applications or upgrade existing applications.

Moreover, the high cost and long lead times for development of new applications has meant that the market for mainframe software applications is, by nature, very small and specialised. The very high cost of mainframes, the relatively small user base, and the need to ensure extremely high reliability in the deployment and execution of mainframe software applications has meant that there is a high cost associated with application development, coupled with a low demand in the marketplace. These market forces, coupled with a very conservative user base of potential clients, have meant that there is little innovation in the field of mainframe software development ecosystem. However, from the existing user base, there is a strong need or desire for new and innovative products in the mainframe software development ecosystem, notwithstanding the overriding issues of reliability, security and long development and testing times.

Embodiments of the present invention ameliorate the need to rigorously test and install new mainframe software applications, as the ‘no-install’ technology which allows an application to be executed on a mainframe computing system without needing to install and test the application beforehand.

Currently, mainframe customers can spend several weeks to a year and $200K to several million dollars, on install and testing effort, for every mainframe software solution and release upgrade they purchase.

The ‘no-install’ technology described above is claimed in another co-pending patent application. The embodiment described herein (referred to as the ‘proxy’) provides another important component which allows for the hosting of applications on a mainframe without requiring any installation of an application. The use of the proxy in conjunction with the no-install technology removes the need to create new software to run on the mainframe for all new mainframe software solutions.

In other words, a user can deploy new software solutions to the mainframe without needing to test the mainframe code, since all Mainspace software solutions will use the same Mainspace mainframe code that was already tested in the first instance.

The cost associated with install/testing of new mainframe software solutions before migrating to production is dramatically reduced in the first instance, and then reduced to almost no additional overhead (in terms of install/testing) for all future Mainspace mainframe solutions (apps) deployed to the platform.

Additionally, as the proxy interfaces directly with the mainframe, new mainframe software applications can be developed in any modern language (such as Web JavaScript) as opposed to the current old languages used (Assembler, COBOL) of which a skills shortage is occurring as mainframe programmers are retiring from the workforce.

The system, method, computer program and data signal in accordance with the embodiment described herein finds use in any situation where it is desirable to execute an application on a mainframe without wishing to expend time and resources testing the application for suitability. The no-install technology interfaces with the broader Mainspace virtual platform solution which are described and defined in other co-pending patent applications filed by Mainframe Cloud Pty Ltd. Together, the no-install technology and the other Mainframe Cloud Pty Ltd solutions address the need in the mainframe market to provide greater and lower cost access to mainframe computing solutions.

### Variations and Modifications

It will be understood that the embodiments and broader invention described herein refer to a mainframe software application, namely a software application arranged to operate on a mainframe computing system. However, the embodiments and broader invention may also find use in analogous situations, such as the operation of software on a server, a distributed computing network, a so-called ‘supercomputer’, or any other use analogous to the use of a mainframe for transactional or calculation computational purposes.

Moreover, it will be understood that aspects or features of the described and defined invention and embodiments thereof may be implemented in hardware (for example, as firmware, as opposed to software which is arranged to interface with hardware via an operating system) may provide particular advantages, such as the ability to better secure communication channels and/or the ability to perform transactions more quickly (which may be important in a busy environment). Such variations are encompassed by the broader inventive concept described herein.

Although not required, the embodiments described with reference to the figures can be implemented via an application programming interface (API), an application development kit (ADK) or as a series of libraries, for use by a developer, for the creation of software applications which are to be used on any one or more mainframe computing platforms or analogous devices, such as a server structure, including a ‘data farm’ or within a bespoke transaction processing system.

Generally, as program modules include routines, programs, objects, components and data files that perform or assist in the performance of particular functions, it will be understood that the functionality of the software applications described and defined herein may be distributed across a number of routines, programs, objects or components to achieve the same functionality as the embodiments and the broader invention claimed herein. Such variations and modifications are within the purview of those skilled in the art.

It will also be appreciated that the methods and systems of the present invention and/or embodiments are implemented by mainframe computing systems or partly implemented by mainframe computing systems then any appropriate mainframe computing system architecture may be utilised.

Where the terms “computer”, “computing system” and “computing device” are used in the specification, these terms are intended to cover any appropriate arrangement of computer hardware for implementing the inventive concept and/or embodiments defined and described herein.

1. A computer enabled method of hosting at least one program on a mainframe computing system, comprising the steps of:
providing to the mainframe system an agent application arranged to interface with at least one of the operating system and the hardware of the mainframe, the agent including an Application Program Interface (API) arranged to receive at least one instruction from a remote source, wherein, upon the instruction being received, the agent application executes the instruction on the mainframe.

2. A method in accordance with claim 1, comprising the further step of starting a virtual server on the mainframe computing system, wherein the at least one instruction is executed within the virtual server.

3. The method in accordance with claim 1, wherein the at least one instruction is an application received by the agent application.

4. The method in accordance with claim 1, wherein the at least one instruction is in the form of a processable job.

5. The method in accordance with claim 4, wherein the processable job is a Job Control Language (JCL) job.

6. The method in accordance with claim 5, wherein the processable job is embodied in a Java Application.

7. The method in accordance with claim 4, wherein the mainframe receives the processable job file using the File Transfer Protocol (FTP).

8. The method in accordance with claim 1, wherein the agent application includes a virtual processor and a communications layer.

9. The method in accordance with claim 8, wherein the agent application is capable of interfacing with at least one of a System Display and Search Facility (SDSF), a SYSLOG Interface, a Time Sharing Option (TSO) interface, a DATASET Interface, a USER Commands Interface and a MVS System Commands Interface.

10. A system for hosting at least one program on a mainframe system, comprising:
an agent application arranged to interface with at least one of the operating system and the hardware of the mainframe, the agent including an Application Program Interface (API) arranged to receive at least one instruction from a remote source, wherein, upon the instruction being received, the agent application executing the instruction on the mainframe.

11. A system in accordance with claim 10, wherein the system includes a virtual server, wherein the at least one instruction is executed within the virtual server.

12. A system in accordance with claim 10, wherein the at least one instruction is an application received by the agent application.

13. A system in accordance with claim 10, wherein the at least one instruction is in the form of a processable job.

14. A system in accordance with claim 13, wherein the processable job is a Job Control Language (JCL) job.

15. A system in accordance with claim 13, wherein the processable job is embodied in a Java Application.

16. A system in accordance with claim 13, wherein the mainframe receives the processable job file using the File Transfer Protocol (FTP).

17. A system in accordance with claim 10, wherein the agent application includes a virtual processor and a communications layer.

18. A system in accordance with claim 10, wherein the agent application is capable of interfacing with at least one of a System Display and Search Facility (SDSF), a SYSLOG Interface, a Time Sharing Option (ISO) interface, a DATASET Interface, a USER Commands Interface and a MVS System Commands Interface.

19.-20. (canceled)
